(19) United States
(12) Patent Application Publication
(10) Pub. No.: US 2015/0221282 A1
(43) Pub. Date: Aug. 6, 2015

(54) METHOD OF CALCULATING OVER-DRIVE TARGET

(71) Applicant: Shenzhen China Star Optoelectronics Technology Co. Ltd., Shenzhen, Guangdong (CN)

(72) Inventor: Lixuan Chen, Shenzhen (CN)

(21) Appl. No.: 14/235,695

(22) PCT Filed: Jan. 3, 2014
(86) PCT No.: PCT/CN2014/070052

§ 371 Date: Jan. 28, 2014

(30) Foreign Application Priority Data
Dec. 11, 2013 (CN) 2013108676668.3

(51) Int. Cl. G09G 5/10; G09G 5/18; G09G 3/36

(52) U.S. Cl. CPC G09G 5/10; G09G 3/3696; G09G 5/18

(57) ABSTRACT

The present invention provides a method for calculating an over-drive target, which follows a predetermined sequence to perform trials of over-drive target values to identify the R/G/B brightness-response time curve of the over-drive target value that matches target brightness and compares response time of the R/G/B brightness-response time curve that matches the target brightness to identify the over-drive target value, whereby achieves automatic calculation of the over-drive target value of the over-drive chart so as to save human labor, increase efficiency, be better fit to the principle of the over-drive technique, and provide an excellent effect of over driving.

### BACKGROUND OF THE INVENTION

1. Field of the Invention

The present invention relates to the field of display technology, and in particular to a method of calculating an over-drive target.

2. the Related Arts

Liquid crystal displays (LCDs) have a variety of advantages, such as thin device body, low power consumption, and being free of radiation, and are thus of wide applications. Most of the liquid crystal displays that are currently available in the market are backlighting liquid crystal displays, which comprise a liquid crystal display panel and a backlight module. The operation principle of a liquid crystal display panel is that with a liquid crystal interposed between two parallel glass substrates, a driving voltage is applied to the two glass substrates to control liquid crystal molecules contained in the liquid crystal material to change direction in order to refract out light emitting from the backlight module for generating images.

Liquid crystal response time is an important parameter to determine the quality of a liquid crystal display. ISO (IS013406-2) provides specifications for the liquid crystal response time. When a pixel changes from white to black, the voltage of the pixel electrode changes from 0 to the maximum, meaning under excitation caused by the maximum voltage, the liquid crystal molecules quickly switch to the new positions, and this process is referred to as a period of rise time; and when a pixel changes from black to white, the voltage applied to the pixel electrode is cut off so that the liquid crystal molecules quickly returns to the position before the voltage has been applied and this process is referred to as a period of fall time. The entire response time of the liquid crystal is the value obtained by summing the rise time and the fall time. Starting from the theory of grey level, the response time is in fact the twisting speed of the liquid crystal molecules. To make the liquid crystal move faster, methods for enhancing the twisting speed of the liquid crystal molecules generally include the following three ways.

(1) Increasing driving voltage: the twisting speed of the liquid crystal molecules is related to the voltage and the higher the voltage is, the faster the liquid crystal molecules twist.

(2) Altering initial condition of liquid crystal molecules: this method is actually to set the liquid crystal molecules in an unstable condition, whereby once “triggered”, a response can be immediately achieved in order to shorten the response time. This method cannot be used without constraint for the liquid crystal molecules cannot be kept very unstable, otherwise they cannot be effectively controlled.

(3) Reducing viscosity of liquid crystal material: The more viscos the liquid crystal material is, the more effort it needs to make a move. By diluting the liquid crystal material, driving it to twist would be easier and the response time should be improved. However, the dilution of the liquid crystal material affects the capability of controlling light so that although the response time can be improved, the price to be paid is relatively high. The lower the viscosity of the liquid crystal material is, the darker the image colors will be and the fainter the image details would be. Further, slight light leak might also result. This is one of the important reasons that Lucky Goldstar Corporation, South Korean, only uses the grey level technology in their super in-plane switching (S-IPS) panels.

Since the second and third ways suffer great drawbacks, the common practice that is currently adopted to shorten the grey level response time is to increase voltage. This is referred to as “over-drive” technology in panel user companies (such as AU optronics Corp.) It can be seen from FIGS. 1 and 2, from grey level 32 to grey level 128, the twisting speed of the liquid crystal molecules is much faster with over-driving than without over-driving.

Filing in an over-drive table generally relies on an engineer's subjective determination whether or not a brightness-response time curve has exhibited an effect of over driving by making trials of various over-drive signals. It is commonly considered adequate to take the (n+1)th frame as a reference to set the brightness curve horizontal, as shown in FIG. 3. Such a process that relies on visual inspection and determination of the engineer and requires multiple times of trial to obtain an over-drive table generally consumes a great amount of time and labor and is of low efficiency.

### SUMMARY OF THE INVENTION

An object of the present invention is to provide a method for calculating an over-drive target, which allows for automatic computation of an over-drive target value of an over-drive table so as to save human labor, increase efficiency, be better fit to the principle of the over-drive technique, and provide an excellent effect of over driving.

To achieve the above object, the present invention provides a method for calculating an over-drive target, which comprises the followings steps:

(1) performing dynamic switching among four frames, which includes a first to a fourth frames, according to a starting grey level and an ending grey level of a selected chart of an over-drive table to be completed;

(2) trying an over-drive target value in order to obtain an R/G/B brightness-response time curve of the over-drive target value;

(3) subjecting the R/G/B brightness-response time curve obtain in step (2) to a noise reduction and smoothening treatment;

(4) taking brightness value of the third frame of step (1) as target brightness and determining if the R/G/B brightness-response time curve obtained with the over-drive target value shows brightness that matches the target brightness and if yes, going to step (5), otherwise repeating steps (2)-(4);

(5) if the brightness of the R/G/B brightness-response time curve of the over-drive target value of the trial is first brightness that matches the target brightness, filling the over-drive target value in a corresponding position in the over-drive table to be completed and repeating steps (2)-(4); and if the brightness of the R/G/B brightness-response time curve of the over-drive target value of the trial is not first brightness that matches the target brightness, comparing response time of the R/G/B brightness-response time curve obtained with the over-drive target value to response time of the R/G/B brightness-response time curve obtained with an over-drive target value set in a corresponding position in the over-drive table to be completed and going to step (6);

(6) if the response time of the R/G/B brightness-response time curve obtained with the over-drive target value of the trial is less than the response time of the R/G/B brightness-response time curve obtained with the over-drive target value of the corresponding position in the over-drive table to be completed, replacing the over-drive target value of the corresponding position in the over-drive table to be completed with the over-drive target value of the trial and repeating steps (2)-(5); if the response time of the R/G/B brightness-response time curve obtained with the over-drive target value of the trial is greater than the response time of the R/G/B brightness-response time curve obtained with the over-drive target value of the corresponding position in the over-drive table to be completed, setting the over-drive target value of the corresponding position in the over-drive table to be completed to be finally determined over-drive target value and going to step (7); and

(7) repeating steps (1)-(6) until calculation of all over-drive target values of the over-drive table.

The over-drive table to be completed is a 17*17 over-drive table and for each time of repeating step (1), at least one of the starting grey level and the ending grey level of the selected chart of the over-drive table to be completed is different.

For each time of repeating step (2), the over-drive target value that is used for trial is different.

Based on sequence of repeating, the over-drive target values are tried in step (2) in a sequence from the smallest to the largest.

Based on sequence of repeating, the over-drive target values are tried in step (2) in a sequence from the largest to the smallest.

In step (3), a median filter is used to perform noise reduction and smoothening treatment on the R/G/B brightness-response time curve obtained in step (2).

In case of being from a low grey level to a high grey level, the maximum value of the brightness of Step 4 to be matched with the target brightness must be less than 105% of the target brightness.

In case of being from a high grey level to a low grey level, the minimum value of the brightness of Step 4 to be matched with the target brightness must be greater than 95% of the target brightness.

In step (5), the over-drive target value can be determined by comparing original data of the R/G/B brightness-response time curve.

The third frame has a brightness value of 3000 lumens.

The present invention also provides a method for calculating an over-drive target, which comprises the followings steps:

(1) performing dynamic switching among four frames, which includes a first to a fourth frames, according to a starting grey level and an ending grey level of a selected chart of an over-drive table to be completed;

(2) trying an over-drive target value in order to obtain an R/G/B brightness-response time curve of the over-drive target value;

(3) subjecting the R/G/B brightness-response time curve obtain in step (2) to a noise reduction and smoothening treatment;

(4) taking brightness value of the third frame of step (1) as target brightness and determining if the R/G/B brightness-response time curve obtained with the over-drive target value shows brightness that matches the target brightness and if yes, going to step (5), otherwise repeating steps (2)-(4);

(5) if the brightness of the R/G/B brightness-response time curve of the over-drive target value of the trial is first brightness that matches the target brightness, filling the over-drive target value in a corresponding position in the over-drive table to be completed and repeating steps (2)-(4); and if the brightness of the R/G/B brightness-response time curve of the over-drive target value of the trial is not first brightness that matches the target brightness, comparing response time of the R/G/B brightness-response time curve obtained with the over-drive target value to response time of the R/G/B brightness-response time curve obtained with an over-drive target value set in a corresponding position in the over-drive table to be completed and going to step (6);

(6) if the response time of the R/G/B brightness-response time curve obtained with the over-drive target value of the trial is less than the response time of the R/G/B brightness-response time curve obtained with the over-drive target value of the corresponding position in the over-drive table to be completed, replacing the over-drive target value of the corresponding position in the over-drive table to be completed with the over-drive target value of the trial and repeating steps (2)-(5); if the response time of the R/G/B brightness-response time curve obtained with the over-drive target value of the trial is greater than the response time of the R/G/B brightness-response time curve obtained with the over-drive target value of the corresponding position in the over-drive table to be completed, setting the over-drive target value of the corresponding position in the over-drive table to be completed to be finally determined over-drive target value and going to step (7); and

(7) repeating steps (1)-(6) until calculation of all over-drive target values of the over-drive table;

wherein the over-drive table to be completed is a 17*17 over-drive table and for each time of repeating step (1), at least one of the starting grey level and the ending grey level of the selected chart of the over-drive table to be completed is different;

wherein for each time of repeating step (2), the over-drive target value that is used for trial is different;

wherein based on sequence of repeating, the over-drive target values are tried in step (2) in a sequence from the smallest to the largest; and

wherein in step (3), a median filter is used to perform noise reduction and smoothening treatment on the R/G/B brightness-response time curve obtained in step (2).

In case of being from a low grey level to a high grey level, the maximum value of the brightness of Step 4 to be matched with the target brightness must be less than 105% of the target brightness.

In case of being from a high grey level to a low grey level, the minimum value of the brightness of Step 4 to be matched with the target brightness must be greater than 95% of the target brightness.

In step (5), the over-drive target value can be determined by comparing original data of the R/G/B brightness-response time curve.

The third frame has a brightness value of 3000 lumens.

The efficacy of the present invention is that the present invention provides a method for calculating an over-drive target, which follows a predetermined sequence to perform trials of over-drive target values to identify the R/G/B brightness-response time curve of the over-drive target value that matches target brightness and compares response time of the R/G/B brightness-response time curve that matches the target brightness to identify the over-drive target value, whereby achieves automatic calculation of the over-drive target value of the over-drive chart so as to save human labor, increase efficiency, be better fit to the principle of the over-drive technique, and provide an excellent effect of over driving.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 shows a brightness-response time curve of a known technique from grey level 32 to grey level 128 without over driving;

FIG. 2 shows a brightness-response time curve of a known technique from grey level 32 to grey level 128 with over driving;

FIG. 3 is an optic response sequence diagram of a conventional liquid crystal display;

FIG. 4 is a flow chart illustrating a method for calculating an over-drive target according to the present invention; and

FIG. 5 is a diagram showing comparison before and after noise-reduced smoothening of a red light brightness-response time curve according to the present invention.

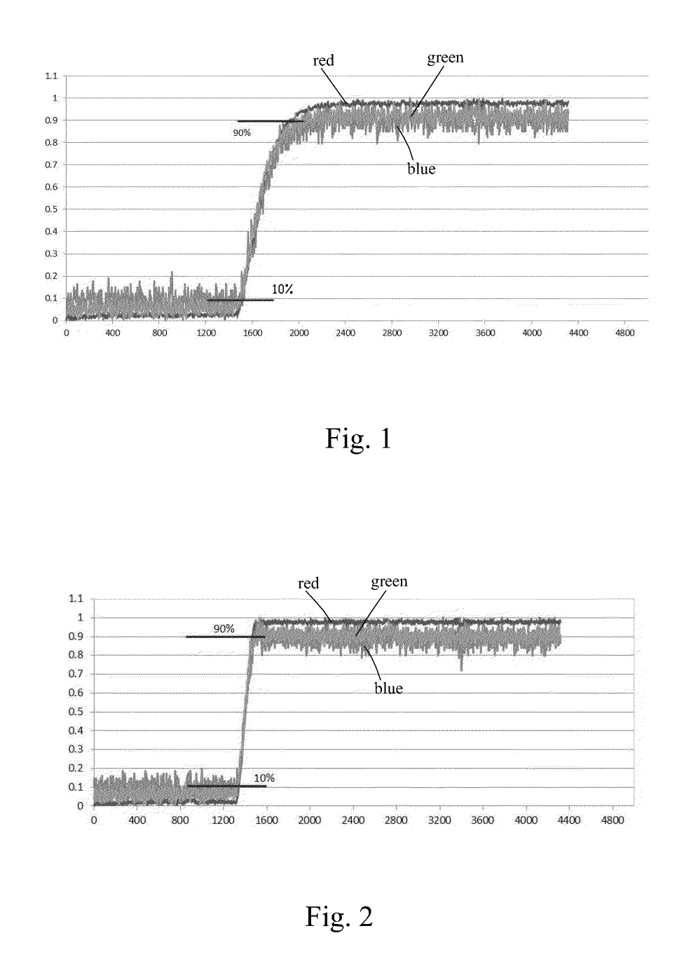

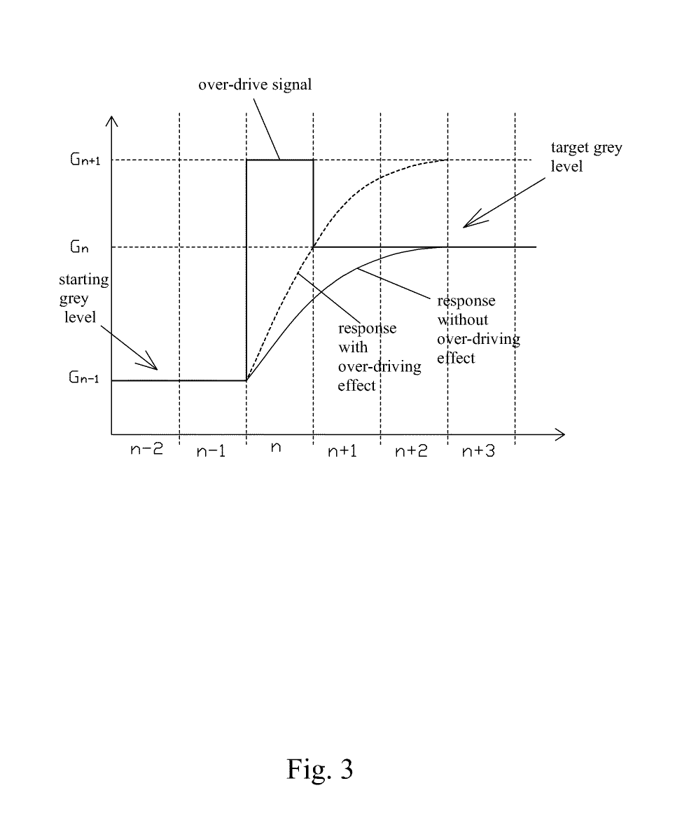

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

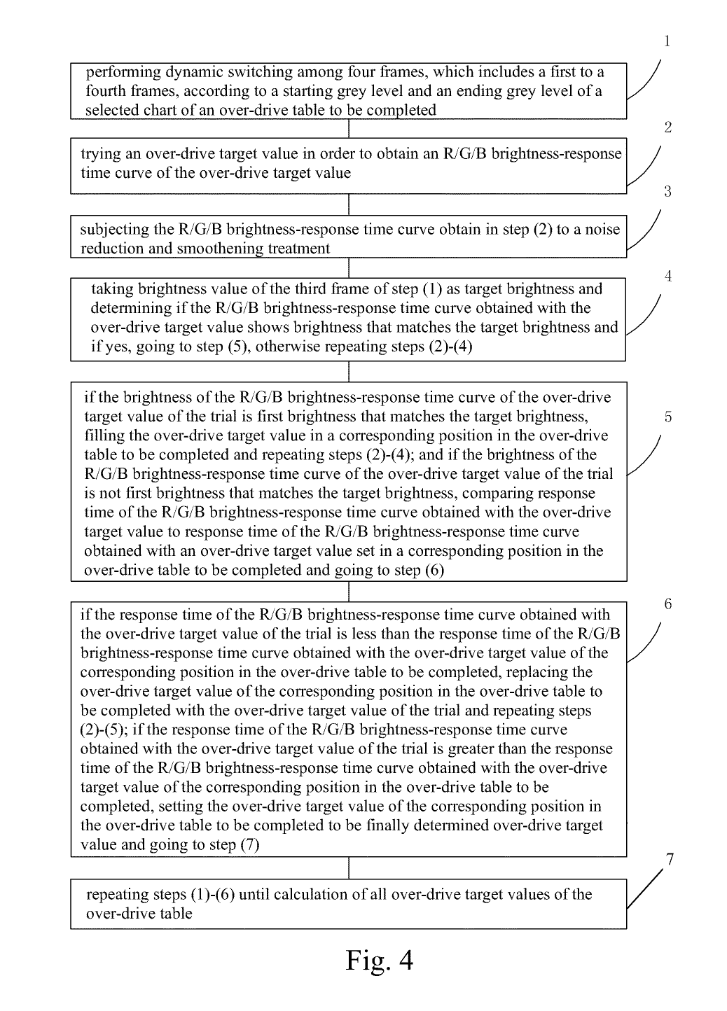

Referring to FIG. 4, the present invention provides a method for calculating the over-drive target, which comprises the following steps:

Step 1: performing dynamic switching among four frames, which includes a first to a fourth frames, according to a starting grey level and an ending grey level of a selected chart of an over-drive table to be completed.

In the instant embodiment, the over-drive table to be completed is a 17*17 over-drive table, but not limited thereto.

When the step is repeated, for each time of repeating, the chart selected is a different one. In other words, for each time of repeating, at least one of the starting grey level and the ending grey level of the selected chart of the over-drive table to be completed is different.

The first frame is a drive signal for achieving the starting grey level; the second frame is a drive signal for achieving a grey level between the starting grey level and the ending grey level; and the third frame and the fourth frame are drive signals for achieving the ending grey level.

Step 2: trying an over-drive target value in order to obtain an R/G/B brightness-response time curve of the over-drive target value.

When the step is repeated, for each time of repeating, the over-drive target value that is used for trial is different. Based on the sequence of repeating, the over-drive target values are tried in a sequence from the smallest to the largest or from the largest to the smallest and, practically, selection can be made according to actual needs.

Step 3: subjecting the R/G/B brightness-response time curve obtain in Step 2 to a noise reduction and smoothening treatment.

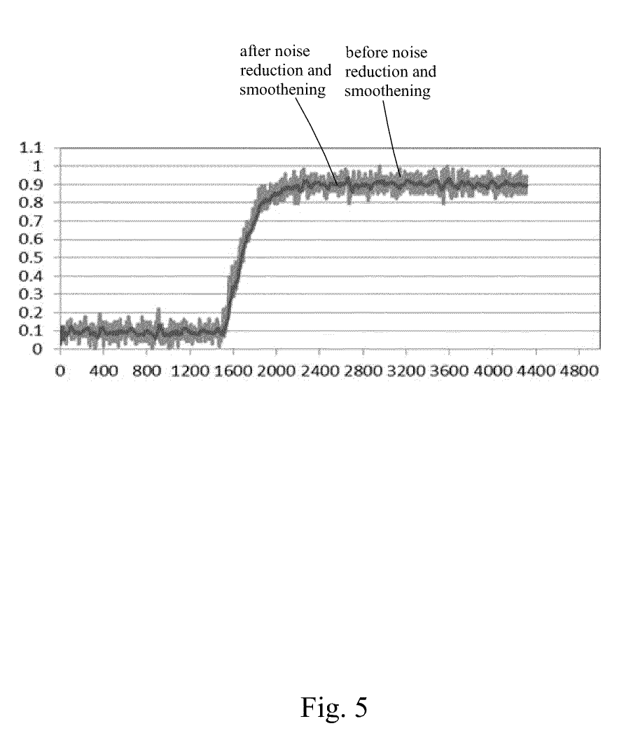

In this step, a median filter is used to perform noise reduction and smoothening treatment on the R/G/B brightness-response time curve obtained in Step 2. Referring to FIG. 5, which is a diagram showing comparison before and after noise-reduced smoothening of a red light brightness-response time curve, after being treated with the median filter, an original measurement curve that comprises noise can be smoothened to enhance accuracy and speed of subsequent calculation.

Step 4: taking brightness value of the third frame of Step 1 as target brightness and determining if the R/G/B brightness-response time curve obtained with the over-drive target value shows brightness that matches the target brightness and if yes, going to Step 5, otherwise repeating Steps 2-4.

In this step, the brightness value of the third frame is approximately 3000 lumens (LM) and rule for matching the brightness of the R/G/B brightness-response time curve of the over-drive target value with the target brightness is as follows:

In case of being from a low grey level to a high grey level, the maximum value of the brightness of Step 4 to be matched with the target brightness must be less than 105% of the target brightness and satisfaction of the requirement can well achieve a better effect of over driving from the low grey level to the high grey level.

In case of being from a high grey level to a low grey level, the minimum value of the brightness of Step 4 to be matched with the target brightness must be greater than 95% of the target brightness and satisfaction of the requirement can well achieve a better effect of over driving from the high grey level to the low grey level.

Step 5: if the brightness of the R/G/B brightness-response time curve of the over-drive target value of the trial is first brightness that matches the target brightness, filling the over-drive target value in a corresponding position in the over-drive table to be completed and repeating Steps 2-4; and if the brightness of the R/G/B brightness-response time curve of the over-drive target value of the trial is not first brightness that matches the target brightness, comparing response time of the R/G/B brightness-response time curve obtained with the over-drive target value to response time of the R/G/B brightness-response time curve obtained with an over-drive target value set in a corresponding position in the over-drive table to be completed and going to Step 6.

Step 6: if the response time of the R/G/B brightness-response time curve obtained with the over-drive target value of the trial is less than the response time of the R/G/B brightness-response time curve obtained with the over-drive target value of the corresponding position in the over-drive table to be completed, replacing the over-drive target value of the corresponding position in the over-drive table to be completed with the over-drive target value of the trial and repeating Steps 2-5; if the response time of the R/G/B brightness-response time curve obtained with the over-drive target value of the trial is greater than the response time of the R/G/B brightness-response time curve obtained with the over-drive target value of the corresponding position in the over-drive table to be completed, setting the over-drive target value of the corresponding position in the over-drive table to be completed to be finally determined over-drive target value and going to Step 7.

The over-drive target value can be determined by comparing the original data of the R/G/B brightness-response time curve having a starting grey level of 32 and target grey levels including 0-255 grey levels.

Step 7: repeating Steps 1-6 until calculation of all over-drive target values of the over-drive table.

By repeating Steps 1-6, determining and filling for the entire over-drive table to be completed can be automatically carried out so as to save human labor, increase efficiency, and achieve excellent effect of over driving.

In summary, the present invention provides a method for calculating an over-drive target, which follows a predetermined sequence to perform trials of over-drive target values to identify the R/G/B brightness-response time curve of the over-drive target value that matches target brightness and compares response time of the R/G/B brightness-response time curve that matches the target brightness to identify the over-drive target value, whereby achieves automatic calculation of the over-drive target value of the over-drive chart so as to save human labor, increase efficiency, be better fit to the principle of the over-drive technique, and provide an excellent effect of over driving.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for calculating an over-drive target, comprising the followings steps:
(1) performing dynamic switching among four frames, which includes a first to a fourth frames, according to a starting grey level and an ending grey level of a selected chart of an over-drive table to be completed;
(2) trying an over-drive target value in order to obtain an R/G/B brightness-response time curve of the over-drive target value;
(3) subjecting the R/G/B brightness-response time curve obtain in step (2) to a noise reduction and smoothening treatment;
(4) taking brightness value of the third frame of step (1) as target brightness and determining if the R/G/B brightness-response time curve obtained with the over-drive target value shows brightness that matches the target brightness and if yes, going to step (5), otherwise repeating steps (2)-(4);
(5) if the brightness of the R/G/B brightness-response time curve of the over-drive target value of the trial is first brightness that matches the target brightness, filling the over-drive target value in a corresponding position in the over-drive table to be completed and repeating steps (2)-(4); and if the brightness of the R/G/B brightness-response time curve of the over-drive target value of the trial is not first brightness that matches the target brightness, comparing response time of the R/G/B brightness-response time curve obtained with the over-drive target value to response time of the R/G/B brightness-response time curve obtained with an over-drive target value set in a corresponding position in the over-drive table to be completed and going to step (6);
(6) if the response time of the R/G/B brightness-response time curve obtained with the over-drive target value of the trial is less than the response time of the R/G/B brightness-response time curve obtained with the over-drive target value of the corresponding position in the over-drive table to be completed, replacing the over-drive target value of the corresponding position in the over-drive table to be completed with the over-drive target value of the trial and repeating steps (2)-(5); if the response time of the R/G/B brightness-response time curve obtained with the over-drive target value of the trial is greater than the response time of the R/G/B brightness-response time curve obtained with the over-drive target value of the corresponding position in the over-drive table to be completed, setting the over-drive target value of the corresponding position in the over-drive table to be completed to be finally determined over-drive target value and going to step (7); and
(7) repeating steps (1)-(6) until calculation of all over-drive target values of the over-drive table.

2. The method for calculating the over-drive target as claimed in claim 1, wherein the over-drive table to be completed is a 17*17 over-drive table and for each time of repeating step (1), at least one of the starting grey level and the ending grey level of the selected chart of the over-drive table to be completed is different.

3. The method for calculating the over-drive target as claimed in claim 1, wherein for each time of repeating step (2), the over-drive target value that is used for trial is different.

4. The method for calculating the over-drive target as claimed in claim 3, wherein based on sequence of repeating, the over-drive target values are tried in step (2) in a sequence from the smallest to the largest.

5. The method for calculating the over-drive target as claimed in claim 3, wherein based on sequence of repeating, the over-drive target values are tried in step (2) in a sequence from the largest to the smallest.

6. The method for calculating the over-drive target as claimed in claim 1, wherein in step (3), a median filter is used to perform noise reduction and smoothening treatment on the R/G/B brightness-response time curve obtained in step (2).

7. The method for calculating the over-drive target as claimed in claim 1, wherein in case of being from a low grey level to a high grey level, the maximum value of the brightness of Step 4 to be matched with the target brightness must be less than 105% of the target brightness.

8. The method for calculating the over-drive target as claimed in claim 1, wherein in case of being from a high grey level to a low grey level, the minimum value of the brightness of Step 4 to be matched with the target brightness must be greater than 95% of the target brightness.

9. The method for calculating the over-drive target as claimed in claim 1, wherein in step (5), the over-drive target value can be determined by comparing original data of the R/G/B brightness-response time curve.

10. The method for calculating the over-drive target as claimed in claim 1, wherein the third frame has a brightness value of 3000 lumens.

11. A method for calculating an over-drive target, comprising the followings steps:
(1) performing dynamic switching among four frames, which includes a first to a fourth frames, according to a starting grey level and an ending grey level of a selected chart of an over-drive table to be completed;
(2) trying an over-drive target value in order to obtain an R/G/B brightness-response time curve of the over-drive target value;
(3) subjecting the R/G/B brightness-response time curve obtain in step (2) to a noise reduction and smoothening treatment;
(4) taking brightness value of the third frame of step (1) as target brightness and determining if the R/G/B brightness-response time curve obtained with the over-drive target value shows brightness that matches the target brightness and if yes, going to step (5), otherwise repeating steps (2)-(4);
(5) if the brightness of the R/G/B brightness-response time curve of the over-drive target value of the trial is first brightness that matches the target brightness, filling the over-drive target value in a corresponding position in the over-drive table to be completed and repeating steps (2)-(4); and if the brightness of the R/G/B brightness-response time curve of the over-drive target value of the trial is not first brightness that matches the target brightness, comparing response time of the R/G/B brightness-response time curve obtained with the over-drive target value to response time of the R/G/B brightness-response time curve obtained with an over-drive target value set in a corresponding position in the over-drive table to be completed and going to step (6);
(6) if the response time of the R/G/B brightness-response time curve obtained with the over-drive target value of the trial is less than the response time of the R/G/B brightness-response time curve obtained with the over-drive target value of the corresponding position in the over-drive table to be completed, replacing the over-drive target value of the corresponding position in the over-drive table to be completed with the over-drive target value of the trial and repeating steps (2)-(5); if the response time of the R/G/B brightness-response time curve obtained with the over-drive target value of the trial is greater than the response time of the R/G/B brightness-response time curve obtained with the over-drive target value of the corresponding position in the over-drive table to be completed, setting the over-drive target value of the corresponding position in the over-drive table to be completed to be finally determined over-drive target value and going to step (7); and
(7) repeating steps (1)-(6) until calculation of all over-drive target values of the over-drive table;
wherein the over-drive table to be completed is a 17*17 over-drive table and for each time of repeating step (1), at least one of the starting grey level and the ending grey level of the selected chart of the over-drive table to be completed is different;
wherein for each time of repeating step (2), the over-drive target value that is used for trial is different;
wherein based on sequence of repeating, the over-drive target values are tried in step (2) in a sequence from the smallest to the largest; and
wherein in step (3), a median filter is used to perform noise reduction and smoothening treatment on the R/G/B brightness-response time curve obtained in step (2).

12. The method for calculating the over-drive target as claimed in claim 11, wherein in case of being from a low grey level to a high grey level, the maximum value of the brightness of Step 4 to be matched with the target brightness must be less than 105% of the target brightness.

13. The method for calculating the over-drive target as claimed in claim 11, wherein in case of being from a high grey level to a low grey level, the minimum value of the brightness of Step 4 to be matched with the target brightness must be greater than 95% of the target brightness.

14. The method for calculating the over-drive target as claimed in claim 11, wherein in step (5), the over-drive target value can be determined by comparing original data of the R/G/B brightness-response time curve.

15. The method for calculating the over-drive target as claimed in claim 11, wherein the third frame has a brightness value of 3000 lumens.
